(19) United States
(12) Patent Application Publication
(10) Pub. No.: US 2020/0307515 A1
(43) Pub. Date: Oct. 1, 2020

(54) VEHICLE CONTROL APPARATUS

(71) Applicant: HONDA MOTOR CO., LTD., Tokyo (JP)

(72) Inventors: Shigenori Hiruta, Wako-shi (JP); Takashi Mori, Wako-shi (JP); Hiroyuki Hayashi, Kawasaki-shi (JP)

(21) Appl. No.: 16/814,081

(22) Filed: Mar. 10, 2020

(30) Foreign Application Priority Data
Mar. 26, 2019 (JP) 2019-057745

(51) Int. Cl. B60R 25/20; G06F 21/31

(52) U.S. Cl. CPC B60R 25/209; G06F 21/31

(57) ABSTRACT

A use control ECU is provided with an ECU storage section that stores wireless communication terminal information, an ECU wireless communication section that communicates with the portable terminal based on the wireless communication terminal information, an authentication information generation section that generates start authorization authentication information for authorizing the vehicle to start, an authentication information notification section that notifies within the vehicle the start authorization authentication information generated by the authentication information generation section, a vehicle start authentication section that performs, when the ECU wireless communication section receives the start authorization authentication information notified from the authentication information notification section from the portable terminal, authentication related to starting the vehicle based on the received start authorization authentication information, and a vehicle start authorization section that authorizes the vehicle to start based on the authentication result of the vehicle start authentication section.

### INCORPORATION BY REFERENCE

The present application claims priority under 35 U.S.C. § 119 to Japanese Patent Application No. 2019-057745 filed on Mar. 26, 2019. The content of the applications is incorporated herein by reference in its entirety.

### BACKGROUND OF THE INVENTION

### Field of the invention

The present invention relates to a vehicle control apparatus that controls a vehicle, which can be started by a portable terminal.

### Description of the Related Art

For a configuration of a vehicle for use in car sharing or the like in which the vehicle is used in turn by a plurality of users, there have conventionally been proposals in which the vehicle can be started when authentication of the users is successful (e.g., see Japanese Patent Application Laid-Open No. 2001-90405). Japanese Patent Application Laid-Open No. 2001-90405 discloses a system that authenticates a user who gets on a vehicle, based on ID information and PIN recorded on an ID card issued for each user and authorizes the vehicle to start when the authentication is successful.

In recent years, for user authentication as described in Japanese Patent Application Laid-Open No. 2001-90405, portable terminals carried by users may be used instead of ID cards. In this case, user authentication is performed by an authentication device communicating with the portable terminal and the vehicle is authorized to start. However, when the above portable terminal is located within a range in which it can communicate and get connected with the above device, the portable terminal may be enabled to automatically communicate and get connected with the above device. For this reason, in the configuration in which the portable terminal performs user authentication, the vehicle may be authorized to start at a place away from the user due to the user's misoperation or the like, so that the vehicle may be illegally used.

An object of the present invention, which has been made in view of the aforementioned circumstances, is to prevent unauthorized use of a vehicle that can be started by a portable terminal.

### SUMMARY OF THE INVENTION

In order to attain the above described object, one aspect of the present invention is a vehicle control apparatus provided with a storage section that stores terminal information on a portable terminal, a communication section that communicates with the portable terminal based on the terminal information stored in the storage section, an authentication information generation section that generates authentication information to authorize the vehicle to start, an authentication information notification section that notifies within a vehicle the authentication information generated by the authentication information generation section, a vehicle start authentication section that performs, when the authentication information notified from the authentication information notification section is received by the communication section from the portable terminal, authentication related to starting the vehicle based on the received authentication information and a vehicle start authorization section that authorizes the vehicle to start based on an authentication result of the vehicle start authentication section.

The above vehicle control apparatus may be provided with an elapsed time measurement section that measures an elapsed time after the authentication information is notified from the authentication information notification section, in which when the elapsed time measured by the elapsed time measurement section reaches a predetermined time, the authentication information notification section is configured to stop notification of the authentication information within the vehicle.

In the above vehicle control apparatus, the authentication information generation section may be configured to generate the authentication information after the authentication information notification section stops notification within the vehicle.

In the above vehicle control apparatus, the authentication information generation section may be configured to generate the authentication information relating to starting the vehicle next time before power of the vehicle is turned off.

The above vehicle control apparatus may be provided with a use reservation acquisition section that acquires a reservation to use the vehicle including a use time of the vehicle, in which the authentication information generation section is configured not to newly generate the authentication information during the use time included in the use reservation acquired by the use reservation acquisition section.

In the above vehicle control apparatus, the authentication information generation section may be configured to generate the authentication information before starting to use the vehicle during the use time.

According to the aspect of the present invention, it is possible to prevent unauthorized use of a vehicle that can be started by a portable terminal.

### BRIEF DESCRIPTION OF THE DRAWINGS

FIG. 1 is a diagram illustrating a configuration of a vehicle control system;

FIG. 2 is a diagram illustrating a configuration of a use management server;

FIG. 3 is a diagram illustrating an example of a server-side user DB;

FIG. 4 is a diagram illustrating an example of use reservation DB;

FIG. 5 is a diagram illustrating a configuration of a vehicle-mounted system;

FIG. 6 is a flowchart illustrating operation of the vehicle-mounted system;

FIG. 7 is a flowchart illustrating operation of an authentication information generation section;

FIG. 8 is a time chart illustrating an example of a use situation of a vehicle by a plurality of users; and

FIG. 9 is a time chart illustrating an example of a use situation of the vehicle by a plurality of users.

### DETAILED DESCRIPTION OF PREFERRED EMBODIMENTS

### [1. Configuration of Vehicle Control System]

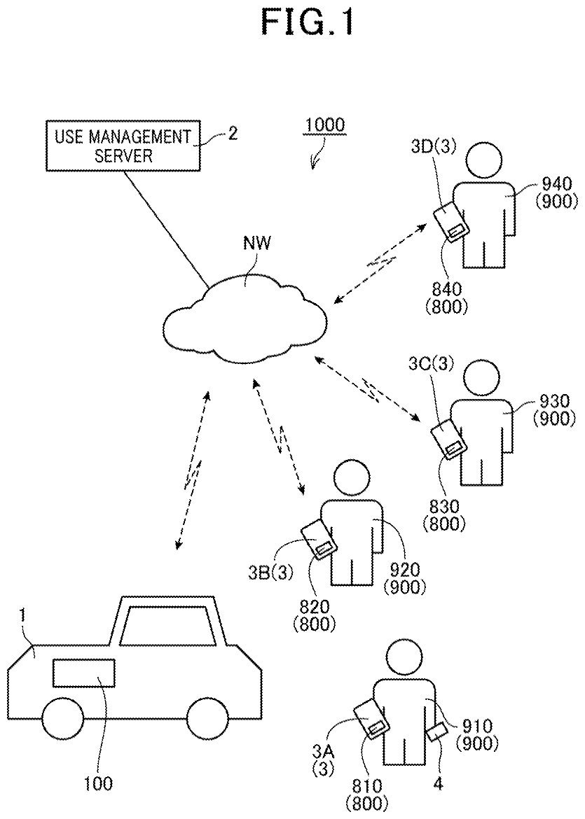

FIG. 1 is a diagram illustrating a configuration of a vehicle control system 1000.

The vehicle control system 1000 is constructed of a vehicle 1 and a use management server 2 communicably connected to the vehicle 1 via a network NW. In the present embodiment, the network NW is, for example, the Internet connected via a public channel or the like.

The vehicle 1 is, for example, a four-wheel passenger automobile used for car sharing or the like, which is used in turn by a plurality of users 900.

In the present embodiment, the users 900 of the vehicle 1 are classified into specific users and non-specific users. The specific users include an owner 910 of the vehicle 1 and people having a predetermined relationship with the owner 910. The non-specific users refer to the users 900 other than specific users. The above predetermined relationship refers to having a family relationship, relationship as relatives, joint purchasers of the vehicle 1 or the like, but the predetermined relationship is not limited to such relationships. The above predetermined relationship can be defined, for example, by the owner 910 of the vehicle 1, and the predetermined relationship may include belonging to a predetermined organization such as belonging to the same company or a club.

In the present embodiment, the vehicle 1 is used by the owner 910, a family user 920 who is a family member of the owner 910, and guest users 930 and 940. The family user 920 is a specific user. The guest users 930 and 940 are non-specific users who borrow and use the vehicle 1 from, for example, the owner 910.

In the following description, the “user 900 other than the owner 910” refers to the family user 920 or the guest user 930 or 940.

The use management server 2 is a server apparatus that performs management relating to use of the vehicle 1. Note that although the use management server 2 is expressed by one block in FIG. 1, this does not necessarily mean that the use management server 2 is composed of a single server apparatus.

The use management server 2 generates a unique electronic key 800 including attribute information 2114 indicating distinction whether the user 900 is a specific user or a non-specific user for the user 900 other than the owner 910 under the approval of the owner 910 of the vehicle 1. The use management server 2 transmits the generated electronic key 800 to the portable terminal 3 of the user 900 other than the owner 910. Note that whether the user 900 other than the owner 910 is a specific user or a non-specific user can be indicated by the owner 910 to the use management server 2 or determined by the use management server 2 based on information provided by the owner 910.

Thus, the vehicle 1 is used by the owner 910 using electronic key 810 stored by the portable terminal 3A or FOB key 4. Furthermore, the vehicle 1 is used by the family user 920 and the guest users 930 and 940 using the electronic keys 820, 830 and 840 issued by the use management server 2 and transmitted to the portable terminals 3B, 3C and 3D.

When using the vehicle 1, the guest user 930 makes a reservation to use the vehicle 1 to the use management server 2. Upon receiving the use reservation, the use management server 2 sets a use time, transmits reservation information 2123 on the use reservation to the vehicle 1, generates an electronic key 830 and transmits the electronic key 830 to the portable terminal 3C. The guest user 930 unlocks or locks the doors of the vehicle 1 using the electronic key 830 issued from the use management server 2, starts the vehicle 1 and uses the vehicle 1 during the use time set in the use reservation. When the use of the vehicle 1 ends, the guest user 930 operates the portable terminal 3C and notifies the use management server 2 that the use of the vehicle 1 has ended. Upon receiving this notification, the use management server 2 transmits to the vehicle 1, a use end notification indicating that the use of the vehicle 1 by the guest user 930 has ended. Note that the guest user 940 uses the vehicle 1 using the portable terminal 3D as in the case of the guest user 930.

When using the vehicle 1, the family user 920 uses the vehicle 1 by unlocking or locking the doors of the vehicle 1 using the electronic key 820 issued in advance and starting the vehicle 1. In the present embodiment, the family user 920 can use the vehicle 1 even in a time zone reserved by the guest user 930 to use the vehicle. Furthermore, the family user 920 may also make a reservation to use the vehicle to the use management server 2 and use the vehicle 1 as with the guest user 930.

When using the vehicle 1, the owner 910 uses the vehicle 1 using the FOB key 4. In the present embodiment, even in a time zone reserved by the guest user 930 or the family user 920 to use the vehicle, the owner 910 can use the vehicle 1 by unlocking the doors of the vehicle 1 or starting the vehicle 1 using the FOB key 4 at his/her own discretion. Furthermore, the owner 910 can also use the vehicle 1 using the portable terminal 3A. The electronic key 810 given to the owner 910 has the same authority as that of the FOB key 4. Therefore, even in a time zone reserved by the guest user 930 or family user 920 to use the vehicle, the owner 910 can use the vehicle 1 by unlocking the doors of the vehicle 1 or starting the vehicle 1 using the portable terminal 3A at his/her own discretion.

The vehicle 1 is provided with a vehicle-mounted system 100. The vehicle-mounted system 100 performs operation related to use of the vehicle 1 by the user 900 in cooperation with the use management server 2.

### [2. Configuration of Use Management Server]

Next, a configuration of the use management server 2 will be described.

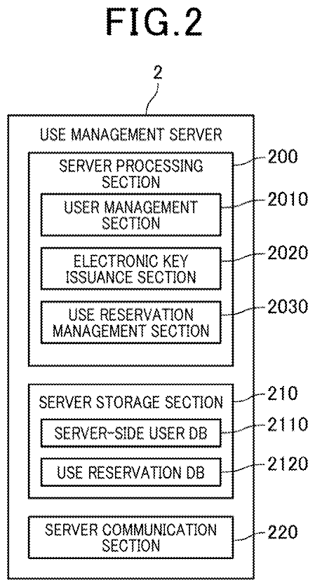

FIG. 2 is a diagram illustrating the configuration of the use management server 2. As shown in FIG. 2, the use management server 2 is provided with a server processing section 200, a server storage section 210 and a server communication section 220 (server receiver/transmitter).

The server processing section 200 is a computer provided with a processor such as a CPU (Central Processing Unit). The server storage section 210 is connected to the server processing section 200. The server storage section 210 stores a control program which is a computer program executed by the server processing section 200, various kinds of data processed by the server processing section 200 so as to be readable by the server processing section 200.

Hardware that constitutes the server processing section 200 and the server storage section 210 is not limited to any specific mode. The server processing section 200 can be constructed of, for example, a single processor. Furthermore, the server processing section 200 may be a device in which a processor, a ROM (Read Only Memory) and a RAM (Random Access Memory) or the like are integrated. The server storage section 210 may be constructed of a non-volatile storage apparatus that stores a program or data in a non-volatile manner, and more specifically, may be provided with a magnetic storage apparatus such as a hard disk or a semiconductor storage device such as a flash ROM. Furthermore, the server storage section 210 may be provided with a volatile storage apparatus that temporarily stores a program or data or the like executed by the server processing section 200. Furthermore, the server processing section 200 and the server storage section 210 may be integrated into one device.

The server processing section 200 is provided with a user management section 2010, an electronic key issuance section 2020 and a use reservation management section 2030 as functional elements or functional units. These functional elements are implemented by the server processing section 200, which is a computer, executing a control program stored in the server storage section 210.

Note that the control program executed by the server processing section 200 may be stored in an arbitrary computer-readable storage medium. Instead, all or some of the above functional elements provided for the server processing section 200 can also be constructed of hardware including one or more electronic circuit parts.

The server processing section 200 controls the respective components of the management server 2 based on data stored in the server storage section 210 by executing the program stored in the server storage section 210.

The server storage section 210 stores a server-side user DB 2110 and a use reservation DB 2120. These databases will be described later.

The server communication section 220 is constructed of communication hardware conforming to a predetermined communication standard and communicates with the vehicle 1 and the portable terminal 3 via the network NW under the control of the server processing section 200.

### [2-1. User Management Section]

The user management section 2010 receives an issuance request for an electronic key 800 from the portable terminal 3 of a use applicant who wants to use the vehicle 1 via the server communication section 220. This issuance request includes the name or the like of the use applicant and access terminal information 2115 for the use management server 2 to access the portable terminal 3 of the use applicant. Upon receiving the issuance request for the electronic key 800, the user management section 2010 transmits a registration approval request including the name or the like of the use applicant to the terminal apparatus owned by the owner 910 (not shown). Note that the portable terminal 3 of the use applicant can transmit the issuance request for the electronic key 800 together with information such as the own name to the use management server 2 via, for example, a browser that accesses a Web site provided by the use management server 2.

When the owner 910 approves the use of the vehicle 1 for the use applicant in response to the received registration approval request, the owner 910 transmits an approval response indicating an approval to the use management server 2 through the terminal apparatus that has received the registration approval request. At this time, the owner 910 inputs relationship information 2113 showing a relationship between the use applicant and the owner 910 (e.g., “family,” “relative,” “friend” and “others”) to the terminal apparatus. With this input, the relationship information 2113 inputted by the owner 910 is included in the approval response transmitted to the use management server 2.

Upon receiving the approval response from the terminal apparatus owned by the owner 910 (not shown), the user management section 2010 sets an attribute of a specific user or non-specific user to the use applicant based on the relationship information 2113 included in the approval response. The user management section 2010 sets this attribute from the relationship information 2113 according to a predetermined rule. The user management section 2010 generates a unique user ID 2111 and unique electronic key basic information 2112 for the use applicant. The electronic key basic information 2112 includes authentication information used by the vehicle 1 to authenticate the electronic key 800. The user management section 2010 generates user information 2116 associated with the generated user ID 2111, electronic key basic information 2112, attribute information 2114 indicating the set attribute and access terminal information 2115 included in the received issuance request for the electronic key 800. The user management section 2010 stores the generated user information 2116 in the server-side user DB 2110 stored in the server storage section 210. Thus, the user management section 2010 registers the use applicant with the server-side user DB 2110.

The server-side user DB 2110 is a database that stores user information 2116 for each user 900 other than the owner 910 for whom the use of the vehicle 1 is approved by the owner 910. The server-side user DB 2110 is also a database that stores the user information 2116 on the owner. Note that the user information 2116 on the owner 910 is stored in advance in the server-side user DB 2110 using a predetermined method.

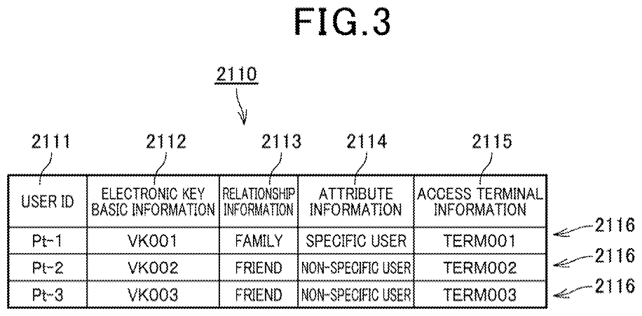

FIG. 3 is a diagram illustrating an example of the server-side user DB 2110.

One piece of the user information 2116 stored in the server-side user DB 2110 includes the user ID 2111, electronic key basic information 2112, relationship information 2113, attribute information 2114 and access terminal information 2115. The server-side user DB 2110 shown in FIG. 3 stores the user information 2116 for each of the owner 910, family user 920 and guest user 930.

### [2-2. Electronic Key Issuance Section]

The electronic key issuance section 2020 issues the electronic key 800 to the user 900 other than the owner 910 registered with the server-side user DB 2110 by the user management section 2010.

When the user management section 2010 has newly registered the user 900 other than the owner 910 with the server-side user DB 2110, if the newly registered user 900 is a specific user, the electronic key issuance section 2020 issues the electronic key 800. More specifically, when the attribute information 2114 of the newly stored user information 2116 indicates a specific user, the electronic key issuance section 2020 refers to the server-side user DB 2110 and acquires the electronic key basic information 2112, attribute information 2114 and access terminal information 2115 on the user 900 corresponding to the user information 2116. The electronic key issuance section 2020 then generates the electronic key 800 including the acquired electronic key basic information 2112 and attribute information 2114 and transmits the electronic key 800 generated based on the acquired access terminal information 2115 to the portable terminal 3 of the newly registered specific user.

In this way, the electronic key 820 to use the vehicle 1 is stored, for example, in the portable terminal 3B of the newly registered family user 920. Note that in the present embodiment, the electronic key 800 stored in the portable terminal 3 of the specific user of the vehicle 1, an expiration date of use of which is indefinite is shown as an example. However, the electronic key 800 stored in the portable terminal 3 of the specific user may be an electronic key 800 having an expiration date set using a predetermined method for a specific user.

The electronic key issuance section 2020 issues the electronic key 800 based on a use reservation of the vehicle 1. More specifically, the electronic key issuance section 2020 receives use reservation information indicating the use reservation of the vehicle 1 from the portable terminal 3 of the user 900 other than the registered owner 910. The use reservation information includes the user ID 2111 of the user 900, who is a transmitter and a desired use time. When the desired use time included in the received use reservation information does not overlap the use time indicated by reservation information 2123 already stored in the use reservation DB 2120, the electronic key issuance section 2020 sets the desired use time as the use time. The electronic key issuance section 2020 generates reservation information 2123 including the user ID 2111 of the user 900 other than the reserved owner 910 and the use time information 2122 indicating the set use time and stores the generated reservation information 2123 in the use reservation DB 2120. The use reservation is completed by storing the reservation information 2123 in the use reservation DB 2120. The electronic key issuance section 2020 refers to the server-side user DB 2110 and generates the electronic key 800 that authorizes the use of the vehicle 1 in the set use time using the electronic key basic information 2112 associated with the user ID 2111 for whom the use reservation has been completed. The electronic key 800 includes use time information 2122 indicating the set use time, a reservation ID 2121 of the use reservation corresponding to the set use time, electronic key basic information 2112 and the attribute information 2114. The electronic key issuance section 2020 transmits the generated electronic key 800 to the portable terminal 3 of the user 900 other than the owner 910 for whom the use reservation has been completed.

In this way, for example, the electronic key 830 including the reservation ID 2121 and the use time information 2122 regarding the use reservation is stored in the portable terminal 3C of the guest user 930 for whom use reservation has been made.

The use reservation DB 2120 is a database that stores one or a plurality of pieces of reservation information 2123.

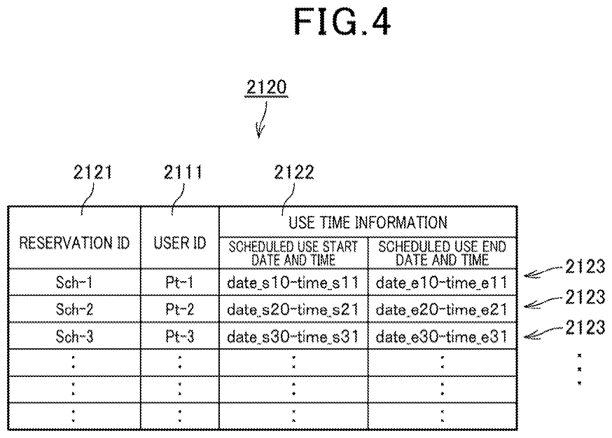

FIG. 4 is a diagram illustrating an example of the use reservation DB 2120.

One piece of the reservation information 2123 stored in the use reservation DB 2120 includes the reservation ID 2121, the user ID 2111 and the use time information 2122.

The use time indicated by the use time information 2122 is comprised of a scheduled use start date and time which is a date and time at which the use is scheduled to start and a scheduled use end date and time which is a date and time at which the use is scheduled to end.

### [2-3. Use Reservation Management Section]

The use reservation management section 2030 manages use reservations made by the user 900 other than the owner 910. The use reservation management section 2030 transmits the reservation information 2123 stored by the electronic key issuance section 2020 in the use reservation DB 2120 to the vehicle 1 via the server communication section 220. When one piece of the reservation information 2123 is stored in the use reservation DB 2120, the use reservation management section 2030 transmits the reservation information 2123 to the vehicle 1 at appropriate timing before the scheduled use start date and time indicated by the use time information 2122 of the reservation information 2123. Furthermore, when a plurality of pieces of reservation information 2123 are stored in the use reservation DB 2120, the use reservation management section 2030 transmits a use end notification to the vehicle 1, includes the reservation information 2123 closest to the scheduled use start date and time with respect to the current time in the use end notification and transmits the reservation information 2123 to the vehicle 1. Upon receiving a notification that the use of the vehicle 1 has ended from the portable terminal 3, the use reservation management section 2030 erases the reservation information 2123 that coincides with the reservation ID 2121 included in the received notification out of the reservation information 2123 stored in the use reservation DB 2120.

### [3. Configuration of Vehicle-Mounted System]

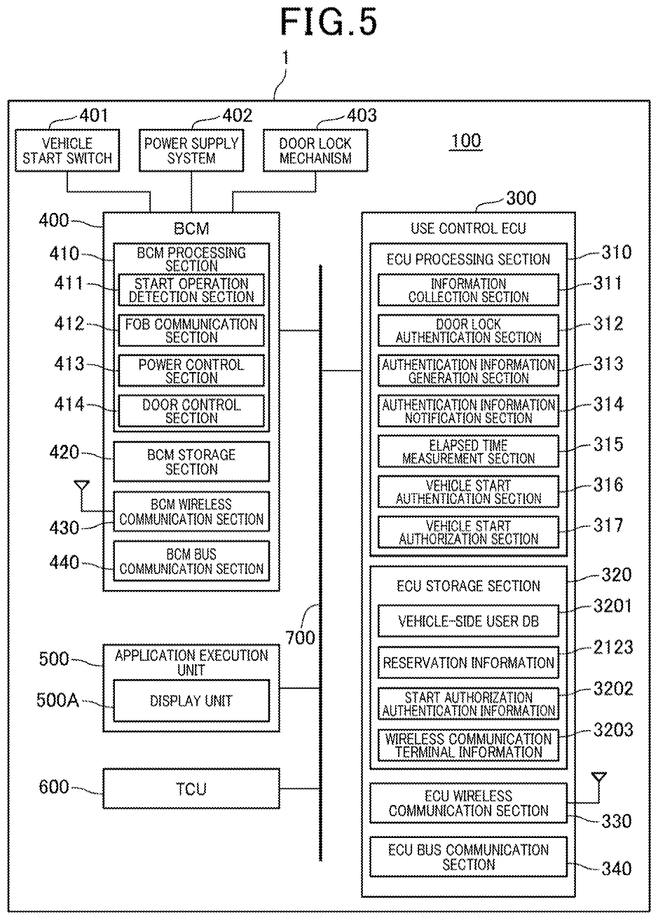

FIG. 5 is a diagram illustrating a configuration of the vehicle-mounted system 100 of the vehicle 1. The vehicle-mounted system 100 is provided with a use control ECU (Electronic Control Unit) 300, which is an electronic control unit (ECU), a body control module (BCM) 400, application execution unit 500 and a telemetry control unit (TCU) 600. The use control ECU 300 corresponds to an example of the vehicle control apparatus of the present invention.

The use control ECU 300, BCM 400, application execution unit 500 and TCU 600 are communicably connected to one another via a vehicle-mounted network bus 700. Here, the vehicle-mounted network bus 700 is, for example, a CAN bus conforming to a CAN (Controller Area Network) communication standard. The application execution unit 500 is a unit in which various application programs are executed. In the present embodiment, the application execution unit 500 is a so-called display audio (DA) having, for example, both audio and image playback functions and is provided with a display unit 500A (display) that displays various kinds of information. The application execution unit 500 is provided within the vehicle 1 so that passengers of the vehicle 1 can see information displayed by the display unit 500A.

### [3-1. Configuration of BCM]

The BCM 400 detects the presence of the FOB key 4 by communicating with the FOB key 4. The BCM 400 also detects operation of a vehicle start switch (Start-Stop Switch) 401 and controls on/off of a power supply system 402 that supplies power to a drive motor (not shown) or the like of the vehicle 1. The BCM 400 controls operation of a door lock mechanism 403 that unlocks/locks the doors of the vehicle 1.

As shown in FIG. 5, the BCM 400 is provided with a BCM processing section 410, a BCM storage section 420, a BCM wireless communication section 430 and a BCM bus communication section 440.

The BCM processing section 410 is, for example, a computer provided with a processor such as a CPU. The BCM storage section 420 is connected to the BCM processing section 410. The BCM storage section 420 stores a control program, which is a computer program executed by the BCM processing section 410 and various kinds of data processed by the BCM processing section 410 so as to be readable by the BCM processing section 410.

Hardware that constitutes the BCM processing section 410 and the BCM storage section 420 is not limited to specific modes as in the cases of the server processing section 200 and the server storage section 210.

The BCM processing section 410 is provided with a start operation detection section 411, a FOB communication section 412, a power control section 413 and a door control section 414 as functional elements or functional units. These functional elements provided for the BCM processing section 410 are implemented by the BCM processing section 410, which is a computer, executing a control program stored in the BCM storage section 420.

Note that the control program executed by the BCM processing section 410 can be stored in any computer-readable storage medium. Instead, all or some of the above functional elements provided in the BCM processing section 410 can also be constructed of hardware including one or more electronic circuit parts.

The BCM processing section 410 controls each part of the BCM 400 based on data stored in the BCM storage section 420 by executing the program stored in the BCM storage section. The BCM processing section 410 controls the BCM wireless communication section 430 and the BCM bus communication section 440.

The BCM wireless communication section 430 is constructed of communication hardware for performing predetermined short distance wireless communication with the FOB key 4, which carries out short distance wireless communication with the FOB key 4 under the control of the BCM processing section 410.

The BCM bus communication section 440 is constructed of a CAN transceiver that communicates with other units via, for example, the vehicle-mounted network bus 700, which is a CAN bus and communicates with each unit connected to the vehicle-mounted network bus 700.

### [3-1-1. Start Operation Detection Section]

Upon detecting that the vehicle start switch 401 is turned on, the start operation detection section 411 requests the FOB communication section 412 to detect the FOB key 4. Upon receiving a notification indicating that the FOB key 4 has been detected from the FOB communication section 412, the start operation detection section 411 requests the power control section 413 to start the vehicle 1. On the other hand, upon receiving a notification indicating that the FOB key 4 has not been detected from the FOB communication section 412, the start operation detection section 411 determines whether or not a start authorization, which is a notification indicating an authorization to start the vehicle 1, has been received from the use control ECU 300. Upon receiving a start authorization notification from the use control ECU 300, the start operation detection section 411 requests the power control section 413 to start the vehicle 1. On the other hand, when a start authorization notification is not received from the use control ECU 300, the start operation detection section 411 does not request the power control section 413 to start the vehicle 1.

Note that in the present embodiment, when the vehicle start switch 401 is turned on, an ignition and accessory power turns on, and so turning on/off the vehicle start switch 401 corresponds to “turning on/off power of the vehicle 1.”

When the start operation detection section 411 requests the power control section 413 to start the vehicle 1, the start operation detection section 411 transmits an execution notification indicating that the start request has been executed to the use control ECU 300 via the BCM bus communication section 440. When the start operation detection section 411 does not request the power control section 413 to start the vehicle 1, the start operation detection section 411 transmits a non-execution notification indicating that the start request is not executed to the use control ECU 300 via the BCM bus communication section 440.

Furthermore, upon detecting that the vehicle start switch 401 has been turned off, the start operation detection section 411 requests the power control section 413 to stop the vehicle 1. After requesting the power control section 413 to stop the vehicle 1, the start operation detection section 411 transmits a notification indicating that the stop request has been made to the use control ECU 300 via the BCM bus communication section 440.

### [3-1-2. FOB Communication Section]

In response to receiving a door unlock request including first authentication information from the FOB key 4, the FOB communication section 412 compares the first authentication information included in the unlock request with second authentication information (not shown) stored in the BCM storage section 420. When the first authentication information included in the door unlock request matches the second authentication information, the FOB communication section 412 transmits an unlock command included in this unlock request to the door control section 414. Upon receiving a door lock request including the first authentication information from the FOB key 4, the FOB communication section 412 compares the first authentication information of the FOB key 4 as in the case of the door unlock request and transmits a lock command to the door control section 414.

### [3-1-3. Power Control Section]

Upon receiving a request to start the vehicle 1 from the start operation detection section 411, the power control section 413 turns on operation of the power supply system 402. This causes the power supply system 402 to start a power supply to the drive motor or the like of the vehicle 1 and enables the vehicle 1 to start. Upon receiving a request to stop the vehicle 1 from the start operation detection section 411, the power control section 413 turns off operation of the power supply system 402.

### [3-1-4. Door Control Section]

Upon receiving an unlock command from the FOB communication section 412 or the use control ECU 300, the door control section 414 causes the door lock mechanism 403 to operate to unlock the doors. On the other hand, upon receiving a lock command from the FOB communication section 412 or the use control ECU 300, the door control section 414 causes the door lock mechanism 403 to operate to lock the doors. The door control section 414 detects a door opening/closing state of the vehicle 1 using an opening/closing sensor (not shown) or the like and transmits a door opening/closing state notification, which is a notification indicating the door opening/closing state to the use control ECU 300.

### [3-2. Configuration of Use Control ECU]

The use control ECU 300 determines whether or not to authorize operation related to the use of the vehicle 1 performed by the user 900 including the owner 910 using the electronic key 800 of the portable terminal 3 and transmits the determination result to the BCM 400.

More specifically, in response to a door unlock request including the electronic key 800 from the portable terminal 3 of the user 900, the use control ECU 300 authenticates this electronic key 800 and determines whether or not the electronic key 800 has the authority to unlock the doors. When the electronic key 800 has the authority to unlock the doors, the use control ECU 300 transmits a door unlock request to the BCM 400 and causes the BCM 400 to unlock the doors. When locking, the use control ECU 300 likewise authenticates the electronic key 800 of the portable terminal 3, and when the authentication is successful, the use control ECU 300 transmits a door lock request to the BCM 400.

Furthermore, in response to receiving a request to start the vehicle 1 including the start authorization authentication information 3202 from the portable terminal 3 of the user 900, the use control ECU 300 determines whether or not to authorize the start of the vehicle 1. Upon determining to authorize the start of the vehicle 1, the use control ECU 300 transmits a request to start the vehicle 1 to the BCM 400 and causes the BCM 400 to start the vehicle 1. Note that the start authorization authentication information 3202 is authentication information to authorize the start of the vehicle 1.

The use control ECU 300 is provided with an ECU processing section 310, an ECU storage section 320, an ECU wireless communication section 330 and an ECU bus communication section 340. The ECU storage section 320 corresponds to an example of the storage section of the present invention. The ECU wireless communication section 330 corresponds to an example of the communication section (receiver/transmitter) of the present invention.

The ECU processing section 310 is, for example, a computer provided with a processor such as a CPU. The ECU storage section 320 is connected to the ECU processing section 310. The ECU storage section 320 stores a control program, which is a computer program executed by the ECU processing section 310 and various kinds of data processed by the ECU processing section 310 so as to be readable by the ECU processing section 310.

Hardware that constitutes the ECU processing section 310 and the ECU storage section 320 is not limited to specific modes as in the cases of the server processing section 200 and the server storage section 210.

The ECU processing section 310 is provided with an information collection section 311, a door lock authentication section 312, an authentication information generation section 313, an authentication information notification section 314, an elapsed time measurement section 315, a vehicle start authentication section 316 and a vehicle start authorization section 317 as functional elements or functional units. These functional elements are implemented by the ECU processing section 310, which is a computer, executing the control program stored in the ECU storage section 320. The information collection section 311 corresponds to an example of the use reservation acquisition section of the present invention.

Note that the control program executed by the ECU processing section 310 can be stored in an arbitrary computer-readable storage medium. Instead, all or some of the above functional elements provided in the ECU processing section 310 can also be constructed of hardware including one or more electronic circuit parts.

The ECU processing section 310 controls the respective components of the use control ECU 300 based on data stored in the ECU storage section 320 by executing the program stored in the ECU storage section 320. The ECU processing section 310 controls the ECU wireless communication section 330 and the ECU bus communication section 340.

The ECU storage section 320 stores a vehicle-side user DB 3201, reservation information 2123, start authorization authentication information 3202 and wireless communication terminal information 3203. The vehicle-side user DB 3201 is a database obtained by the ECU processing section 310 periodically downloading the server-side user DB 2110 owned by the use management server 2. The wireless communication terminal information 3203 corresponds to an example of the terminal information of the present invention. The wireless communication terminal information 3203 is terminal information of the portable terminal 3 used by the ECU wireless communication section 330 to perform short distance wireless communication, and in the case of, for example, Bluetooth (registered trademark), it is information for pairing between the vehicle 1 and the portable terminal 3. The ECU storage section 320 stores one or a plurality of pieces of the wireless communication terminal information 3203 of the portable terminal 3 that wirelessly communicates with the ECU wireless communication section 330.

The ECU wireless communication section 330 is constructed of communication hardware carrying out short distance wireless communication conforming to a short distance communication standard such as Bluetooth. The ECU wireless communication section 330 automatically communicates and gets connected with the portable terminal 3 located in the vehicle room or in the periphery of the vehicle 1 based on the wireless communication terminal information 3203 stored in the ECU storage section 320 and wirelessly communicates with the communicably connected portable terminal 3.

The ECU bus communication section 340 is constructed of a CAN transceiver that communicates with another apparatus such as the BCM 400 via, for example, the vehicle-mounted network bus 700 and communicates with apparatuses connected to the vehicle-mounted network bus 700 under the control of the ECU processing section 310.

### [3-2-1. Information Collection Section]

The information collection section 311 communicates with the use management server 2 at a predetermined interval via the TCU 600 and downloads contents of the server-side user DB 2110. The information collection section 311 stores the downloaded contents of the server-side user DB 2110 in the ECU storage section 320 as the vehicle-side user DB 3201.

The information collection section 311 communicates with the use management server 2 via the TCU 600 and receives reservation information 2123 from the use management server 2. Upon receiving the reservation information 2123, the information collection section 311 causes the ECU storage section 320 to store the received reservation information 2123. The information collection section 311 causing the ECU storage section 320 to store the reservation information 2123 corresponds to “acquiring a reservation to use the vehicle 1.”

Upon receiving a use end notification of the vehicle 1 from the use management server 2, the information collection section 311 erases the reservation information 2123 stored in the ECU storage section 320. When the use end notification received from the use management server 2 includes the reservation information 2123 for the next use reservation, the information collection section 311 causes the ECU storage section 320 to store the reservation information 2123. Note that since the reservation information 2123 includes use time information 2122, the reservation to use the vehicle 1 acquired by the information collection section 311 includes the use time of the vehicle 1.

### [3-2-2. Door Lock Authentication Section]

When a door unlock request including the electronic key 800 is received from the portable terminal 3 located in the vehicle room or in the periphery of the vehicle 1 via the ECU wireless communication section 330, the door lock authentication section 312 authenticates whether or not the electronic key 800 received from the portable terminal 3 is an electronic key 800 having the authority to unlock the doors. When a door lock request including the electronic key 800 is received from the portable terminal 3 located in the periphery of the vehicle 1 via the ECU wireless communication section 330, the door lock authentication section 312 authenticates whether or not the electronic key 800 received from the portable terminal 3 is an electronic key 800 having the authority to lock the doors.

The door lock authentication section 312 performs door lock authentication processing on the electronic key 800 included in the door unlock request or lock request. In the door lock authentication processing, the door lock authentication section 312 determines whether the electronic key basic information 2112 of the target electronic key 800 matches any piece of the electronic key basic information 2112 stored in the vehicle-side user DB 3201 stored in the ECU storage section 320.

When no match is determined, the door lock authentication section 312 assumes that the authentication has failed and determines that the electronic key 800 received from the portable terminal 3 is not the electronic key 800 having the authority to unlock the doors.

When a match is determined, the door lock authentication section 312 acquires the attribute information 2114 from the electronic key 800 received from the portable terminal 3. When the attribute indicated by the acquired attribute information 2114 is a specific user, the door lock authentication section 312 determines that the electronic key 800 received from the portable terminal 3 is an electronic key 800 having the authority to unlock the doors. When the attribute indicated by the acquired attribute information 2114 is a non-specific user, the door lock authentication section 312 acquires the reservation ID 2121 and the use time information 2122 from the electronic key 800 received from the portable terminal 3 and compares them with the reservation information 2123 stored in the ECU storage section 320. When the acquired reservation ID 2121 matches the reservation ID 2121 of the reservation information 2123 stored in the ECU storage section 320 and when the current time falls within the use time indicated by the acquired use time information 2122, the door lock authentication section 312 determines that the electronic key 800 received from the portable terminal 3 is the electronic key 800 having the authority to unlock the doors. On the other hand, when the reservation ID 2121 does not match or when the current time does not fall within the use time indicated by the use time information 2122, the door lock authentication section 312 determines that the electronic key 800 received from the portable terminal 3 is not an electronic key 800 having the authority to unlock the doors.

Upon determining that the electronic key 800 received from the portable terminal 3 is an electronic key 800 having the authority to unlock or lock the doors, the door lock authentication section 312 transmits a door unlock request or lock request to the BCM 400. On the other hand, upon determining that the electronic key 800 received from the portable terminal 3 is not an electronic key 800 having the authority to unlock or lock the doors, the door lock authentication section 312 transmits the fact to the portable terminal 3.

### [3-2-3. Authentication Information Generation Section]

The authentication information generation section 313 generates start authorization authentication information 3202 for authorizing start of the vehicle 1. The authentication information generation section 313 does not generate start authorization authentication information 3202 in cases described later. The authentication information generation section 313 causes the ECU storage section 320 to store the generated start authorization authentication information 3202. When the start authorization authentication information 3202 is newly generated, the authentication information generation section 313 updates the start authorization authentication information 3202 stored in the ECU storage section 320 to the newly generated start authorization authentication information 3202.

### [3-2-4. Authentication Information Notification Section]

The authentication information notification section 314 notifies within the vehicle 1 the start authorization authentication information 3202 by causing the display unit 500A to display the start authorization authentication information 3202 stored in the ECU storage section 320. For example, when the start authorization authentication information 3202 is a sequence of “1234,” the authentication information notification section 314 causes the display unit 500A to display the sequence. Note that the notification mode of the authentication information notification section 314 is not limited to a display by the display unit 500A, but may be a mode in which speech is outputted within the vehicle 1 using a speaker or the like.

### [3-2-5. Elapsed Time Measurement Section]

The elapsed time measurement section 315 measures an elapsed time after the authentication information notification section 314 notifies the start authorization authentication information 3202.

### [3-2-6. Vehicle Start Authentication Section]

Upon receiving a request to start the vehicle 1 including the start authorization authentication information 3202 and the electronic key 800 from the portable terminal 3, the vehicle start authentication section 316 executes start authorization authentication processing on the start authorization authentication information 3202 and the electronic key 800 included in this start request. Note that a program for executing the function of transmitting the request to start the vehicle 1 to the vehicle 1 is preinstalled in the portable terminal 3. The user 900 inputs the start authorization authentication information 3202 to the portable terminal 3, performs operation of confirming the input and thereby transmits the request to start the vehicle 1 to the vehicle 1.

In the start authorization authentication processing, the vehicle start authentication section 316 determines whether or not the start authorization authentication information 3202 matches the start authorization authentication information 3202 stored in the ECU storage section 320. When no match is determined, the vehicle start authentication section 316 assumes that the authentication has failed, determines that the user 900 carrying the portable terminal 3 that has transmitted the request to start the vehicle 1 is not the user 900 having the authority to start the vehicle 1 and transmits this determination result to the vehicle start authorization section 317 as an authentication result.

On the other hand, when a match is determined, the vehicle start authentication section 316 determines whether or not the user 900 carrying the portable terminal 3 that has transmitted the request to start the vehicle 1 is the user 900 having the authority to start the vehicle 1 based on the electronic key basic information 2112, attribute information 2114, reservation ID 2121, and use time information 2122 of the electronic key 800 as in the case of the door lock authentication section 312.

That is, when the electronic key basic information 2112 does not match, the vehicle start authentication section 316 determines that the user 900 carrying the portable terminal 3 that has transmitted the request to start the vehicle 1 is not the user 900 having the authority to start the vehicle 1 and transmits this determination result to the vehicle start authorization section 317 as the authentication result.

When the electronic key basic information 2112 matches and when the attribute indicated by the attribute information 2114 is a specific user, the vehicle start authentication section 316 determines that the user 900 carrying the portable terminal 3 that has transmitted the request to start the vehicle 1 is a user 900 having the authority to start the vehicle 1 and transmits the determination result to the vehicle start authorization section 317 as the authentication result. On the other hand, when the attribute is a non-specific user, if the reservation ID 2121 does not match or the current time does not fall within the use time indicated by the use time information 2122, the vehicle start authentication section 316 makes the same determination as that in the case of a mismatch of the electronic key basic information 2112 and transmits this determination result to the vehicle start authorization section 317 as the authentication result. When the electronic key basic information 2112 and the reservation ID 2121 match and when the current time falls within the use time indicated by the use time information 2122, the vehicle start authentication section 316 determines that the user 900 carrying the portable terminal 3 that has transmitted the request to start the vehicle 1 is the user 900 having the authority to start the vehicle 1 and transmits this determination result to the vehicle start authorization section 317 as the authentication result.

### [3-2-7. Vehicle Start Authorization Section]

The vehicle start authorization section 317 determines whether or not to authorize the vehicle 1 to start based on the determination result of the vehicle start authentication section 316. Upon receiving a determination result that the user 900 carrying the portable terminal 3 that has transmitted the request to start the vehicle 1 is not the user 900 having the authority to start the vehicle 1 from the vehicle start authentication section 316, the vehicle start authorization section 317 determines not to authorize the vehicle 1 to start. On the other hand, upon receiving a determination result that the user 900 carrying the portable terminal 3 that has transmitted the request to start the vehicle 1 is the user 900 having the authority to start the vehicle 1 from the vehicle start authentication section 316, the vehicle start authorization section 317 determines to authorize the vehicle 1 to start. Upon determining to authorize the vehicle 1 to start, the vehicle start authorization section 317 transmits the start authorization notification to the BCM 400. Thus, the vehicle start switch 401 is turned on and the vehicle 1 is enabled to start.

### [4. Processing in Vehicle Control System]

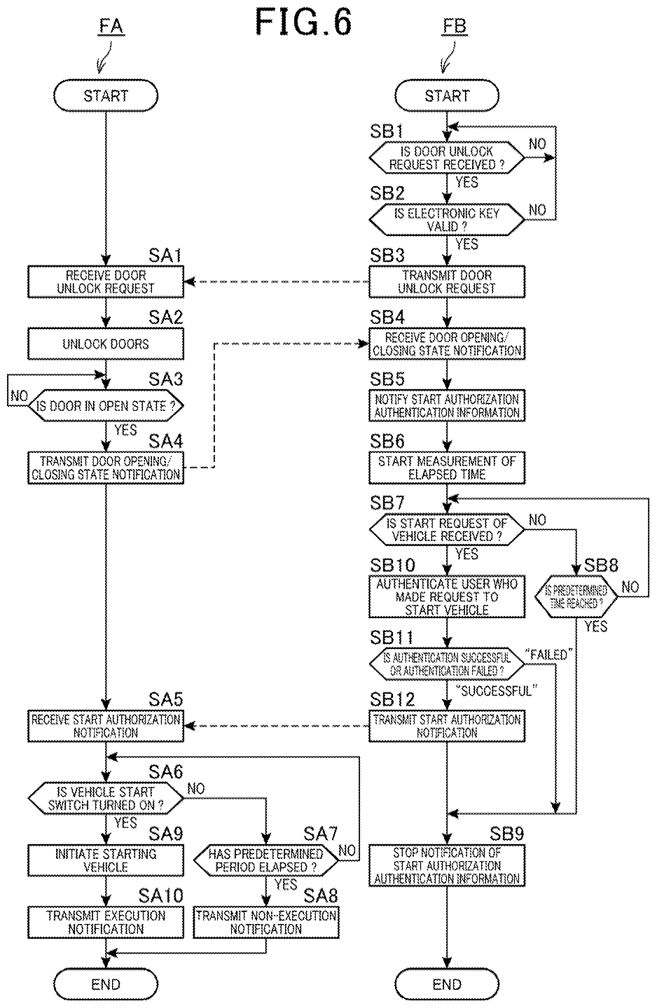

Next, operation of the vehicle-mounted system 100 after the user 900 gets on the vehicle 1 using the portable terminal 3 until the user 900 starts the vehicle 1 will be described with reference to FIG. 6.

FIG. 6 is a flowchart illustrating operation of the vehicle-mounted system 100.

In FIG. 6, a flowchart FA illustrates operation of the BCM 400 of the vehicle-mounted system 100. A flowchart FB illustrates operation of the use control ECU 300 of the vehicle-mounted system 100.

At a start point in time of the flowchart FA or FB in FIG. 6, even when the user 900 is a guest user 930 or 940, it is assumed that the reservations to use the vehicle 1 are appropriately made and the use reservations are appropriately registered with the use management server 2 and the vehicle 1. Note that the fact that the use reservations are registered with the use management server 2 means that the reservation information 2123 corresponding to the use reservation is stored in the use reservation DB 2120 and the fact that the use reservations are registered with the vehicle 1 means that the reservation information 2123 is stored in the ECU storage section 320 of the use control ECU 300.

At the start point in time of the flowchart in FIG. 6, it is assumed that all the doors of the vehicle 1 are locked and the vehicle start switch 401 is off.

With reference to the flowchart FB, the door lock authentication section 312 of the use control ECU 300 of the vehicle-mounted system 100 determines whether or not a door unlock request has been received from the portable terminal 3 of the user 900 (step SB1).

Upon determining that the door unlock request has not been received (step SB1: NO), the door lock authentication section 312 executes the process in step SB1 again and waits for reception of a door unlock request from the portable terminal 3. Note that as described above, this door unlock request includes the electronic key 800 stored in the source portable terminal 3.

On the other hand, upon determining that the door unlock request has been received (step SB1: YES), the door lock authentication section 312 authenticates whether or not the electronic key 800 included in the door unlock request is a valid electronic key 800 (step SB2). That is, the door lock authentication section 312 authenticates whether or not the electronic key 800 included in the unlock request is an electronic key 800 having the authority to unlock the doors.

Upon authenticating that the electronic key 800 included in the door unlock request is not a valid electronic key 800 (step SB2: NO), the door lock authentication section 312 returns the process to step SB1.

On the other hand, upon authenticating that the electronic key 800 included in the door unlock request is a valid electronic key 800 (step SB2: YES), the door lock authentication section 312 transmits a door unlock request to the BCM 400 (step SB3).

With reference to the flowchart FA, the door control section 414 of the BCM 400 of the vehicle-mounted system 100 receives a door unlock request from the use control ECU 300 via the BCM bus communication section 440 (step SA1).

Upon receiving the door unlock request from the use control ECU 300, the door control section 414 causes the door lock mechanism 403 to operate to unlock the doors (step SA2).

Next, the door control section 414 determines whether any one door of the vehicle 1 has transitioned to an open state (step SA3). Upon determining that any one door of the vehicle 1 has not transitioned to an open state (step SA3: NO), the door control section 414 executes the process in step SA3 again.

On the other hand, upon determining that any one door of the vehicle 1 has transitioned to an open state (step SA3: YES), the door control section 414 transmits a door opening/closing state notification indicating that the door is in an open state to the use control ECU 300 via the BCM bus communication section 440 (step SA4).

With reference to the flowchart FB, the authentication information notification section 314 of the use control ECU 300 receives a door opening/closing state notification indicating that the door is in an open state from the BCM 400 via the ECU bus communication section 340 (step SB4).

Next, the authentication information notification section 314 notifies within the vehicle 1 the start authorization authentication information 3202 by causing the display unit 500A to display the start authorization authentication information 3202 stored in the ECU storage section 320 (step SB5).

Next, the elapsed time measurement section 315 starts measurement of an elapsed time after the authentication information notification section 314 notifies the start authorization authentication information 3202 (step SB6).

Next, via the ECU wireless communication section 330, the vehicle start authentication section 316 determines whether or not a request to start the vehicle 1 has been received from the portable terminal 3 (step SB7). Note that as described above, the request to start the vehicle 1 includes the start authorization authentication information 3202 and the electronic key 800 stored in the portable terminal 3.

A program for executing a function of transmitting a request to start the vehicle 1 to the vehicle 1 is preinstalled in the portable terminal 3. The user 900 inputs the start authorization authentication information 3202 to the portable terminal 3 and performs operation to confirm this input, and thereby transmits the request to start the vehicle 1 to the vehicle 1.

When the vehicle start authentication section 316 determines that the request to start the vehicle 1 has not been received from the portable terminal 3 (step SB7: NO), the authentication information notification section 314 determines whether or not the elapsed time measured by the elapsed time measurement section 315 has reached a predetermined time (step SB8).

Upon determining that the elapsed time measured by the elapsed time measurement section 315 has not reached a predetermined time (step SB8: NO), the authentication information notification section 314 returns the process to step SB7 and executes the process in step SB7 again.

On the other hand, upon determining that the elapsed time measured by the elapsed time measurement section 315 has reached a predetermined time (step SB8: YES), the authentication information notification section 314 stops the notification of the start authorization authentication information 3202 (step SB9). In the present embodiment, in step SB9, the authentication information notification section 314 stops the display of the start authorization authentication information 3202 on the display unit 500A of the application execution unit 500.

Thus, when a predetermined time elapses after notifying the start authorization authentication information 3202, the authentication information notification section 314 stops the notification of the start authorization authentication information 3202. Therefore, it is possible to prevent the start authorization authentication information 3202 from being notified unnecessarily from the portable terminal 3 for a long period of time without receiving any request to start the vehicle 1 and prevent power consumption from increasing due to the notification of the start authorization authentication information 3202.

Returning to the description in step SB7, upon determining that a request to start the vehicle 1 has been received from the portable terminal 3 (step SB7: YES), the vehicle start authentication section 316 authenticates the user 900 carrying the portable terminal 3 that has transmitted the start request (step SB10). That is, the vehicle start authentication section 316 determines whether or not the user 900 carrying the portable terminal 3 that has transmitted the request to start the vehicle 1 is the user 900 having the authority to start the vehicle 1. This authentication is authentication related to starting the vehicle 1.

Next, the vehicle start authorization section 317 determines whether or not the authentication in step SB11 has been successful or has failed (step SB11). Upon receiving a determination result in step SB11 that the user 900 carrying the portable terminal 3 that has transmitted the request to start the vehicle 1 is the user 900 having the authority to start the vehicle 1 from the vehicle start authentication section 316, the vehicle start authorization section 317 determines that the authentication in step SB11 has been successful. On the other hand, upon receiving a determination result in step SB11 that the user 900 carrying the portable terminal 3 that has transmitted the request to start the vehicle 1 is not the user 900 having the authority to start the vehicle 1 from the vehicle start authentication section 316, the vehicle start authorization section 317 determines that the authentication in step SB11 has failed.

When the vehicle start authorization section 317 determines that the authentication in step SB11 has failed (step SB11: “failed”), the authentication information notification section 314 executes a process in step SB9 and ends the operation.

On the other hand, upon determining that the authentication in step SB11 has been successful (step SB11: “successful”), the vehicle start authorization section 317 transmits the start authorization notification to the BCM 400 via the ECU bus communication section 340 (step SB12). When the vehicle start authorization section 317 transmits the start authorization notification to the BCM 400, the authentication information notification section 314 executes the process in step SB9 and ends the operation.

With reference to the flowchart FA, the start operation detection section 411 of the BCM 400 receives a start authorization notification via the BCM bus communication section 440 (step SA5).

Next, the start operation detection section 411 determines whether or not the vehicle start switch 401 has been turned on (step SA6). Upon determining that the vehicle start switch 401 has not been turned on (step SA6: NO), the start operation detection section 411 determines whether or not the period during which the vehicle start switch 401 is off after receiving the start authorization notification has passed a predetermined period (step SA7).

Upon determining that the period has not passed the predetermined period (step SA7: NO), the start operation detection section 411 executes the process in step SA6 again. On the other hand, upon determining that the period has passed the predetermined period (step SA7: YES), the start operation detection section 411 transmits a non-execution notification as a notification of the fact that the vehicle 1 cannot be started due to a timeout to the use control ECU 300 via the BCM bus communication section 440 (step SA8), and ends the present operation.

Returning to the description in step SA6, upon determining that the vehicle start switch 401 has been turned on (step SA6: YES), the start operation detection section 411 requests the power control section 413 to start the vehicle 1 and initiates starting the vehicle 1 (step SA9). The start operation detection section 411 transmits an execution notification as a notification of the fact that start of the vehicle 1 has been initiated to the use control ECU 300 via the BCM bus communication section 440 (step SA10), and ends the present operation.

As described above, the authentication information notification section 314 of the use control ECU 300 notifies within the vehicle 1 the start authorization authentication information 3202. When the start authorization authentication information 3202 notified within the vehicle 1 is received from the portable terminal 3, the vehicle start authentication section 316 of the use control ECU 300 performs authentication related to starting the vehicle 1 based on the start authorization authentication information 3202. When this authentication is successful, the vehicle start authorization section 317 of the use control ECU 300 authorizes start of the vehicle 1.

Accordingly, the user 900 needs to recognize the start authorization authentication information 3202 notified within the vehicle 1 to start the vehicle 1 by the portable terminal 3. Therefore, the user 900 needs to get on the vehicle 1 in order to start the vehicle 1 by the portable terminal 3. Therefore, the use control ECU 300 even when configured to automatically communicate and get connected with the portable terminal 3 can prevent the vehicle 1 from being enabled to start at a position away from the user 900 due to a misoperation or the like of the user 900. Therefore, the use control ECU 300 can prevent unauthorized use of the vehicle 1 that can be started by the portable terminal 3.

### [5. Operation of Authentication Information Generation Section]

As described above, the authentication information notification section 314 notifies the start authorization authentication information 3202 stored in the ECU storage section 320, that is, the start authorization authentication information 3202 generated by the authentication information generation section 313. By executing the following operation, the authentication information generation section 313 of the use control ECU 300 makes the vehicle 1 easy to use for the user 900 and can improve security in using the vehicle 1.

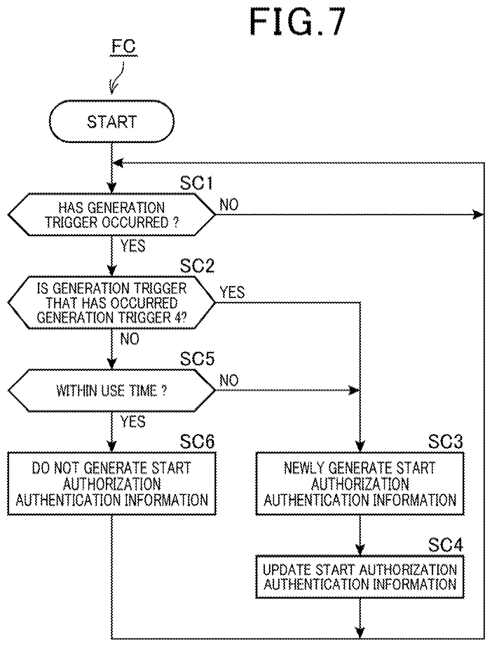

FIG. 7 is a flowchart FC illustrating operation of the authentication information generation section 313.

The authentication information generation section 313 determines whether or not a generation trigger which is a trigger to generate the start authorization authentication information 3202 has occurred (step SC1).

There are four generation triggers in the present embodiment.

### <Generation Trigger 1>

Generation trigger 1: Power of the vehicle 1 is turned on.

Upon receiving an execution notification transmitted from the BCM 400 in step SA10 in FIG. 6, the authentication information generation section 313 determines that a generation trigger 1 has occurred.

### <Generation Trigger 2>

Generation trigger 2: The authentication information notification section 314 receives no request to start the vehicle 1 for a predetermined time after notification of the start authorization authentication information 3202 and authentication based on the start authorization authentication information 3202 times out.

When a positive determination is made in step SB8 in FIG. 6, the authentication information generation section 313 determines that a generation trigger 2 has occurred.

### <Generation Trigger 3>

Generation trigger 3: The vehicle start switch 401 does not transition from off to on for a predetermined period after the BCM 400 receives a start authorization notification from the use control ECU 300 and start of the vehicle 1 times out.

Upon receiving a non-execution notification transmitted from the BCM 400 in step SA8 in FIG. 6, the authentication information generation section 313 determines that a generation trigger 3 has occurred.

### <Generation Trigger 4>

Generation trigger 4: A use end notification has been received from the use management server 2.

Upon receiving a use end notification from the use management server 2, the authentication information generation section 313 determines that a generation trigger 4 has occurred.

Returning to the description of the flowchart FC in FIG. 7, upon determining that no generation trigger has occurred (step SC1: NO), the authentication information generation section 313 executes the process in step SC1 again.

On the other hand, upon determining that a generation trigger has occurred (step SC1: YES), the authentication information generation section 313 determines whether or not the generation trigger that has occurred is a generation trigger 4 (step SC2).

Upon determining that the generation trigger that has occurred is a generation trigger 4 (step SC2: YES), the authentication information generation section 313 generates start authorization authentication information 3202, which is different from the start authorization authentication information 3202 stored in the ECU storage section 320 (step SC3). The authentication information generation section 313 then updates the start authorization authentication information 3202 stored in the ECU storage section 320 to the newly generated start authorization authentication information 3202 (step SC4). After executing the process in step SC4, the authentication information generation section 313 returns the process to step SC1.

Returning to the description in step SC2, if it is determined that the generation trigger that has occurred is not the generation trigger 4 (step SC2: NO), that is, that the generation trigger that has occurred is any one of the generation triggers 1 to 3, the authentication information generation section 313 determines whether or not the current time falls within the use time indicated by the reservation information 2123 stored in the ECU storage section 320 (step SC5).

Upon determining that the current time does not fall within the use time indicated by the reservation information 2123 stored in the ECU storage section 320 (step SC5: NO), the authentication information generation section 313 executes the processes in steps SC3 and SC4. That is, the authentication information generation section 313 newly generates start authorization authentication information 3202 and updates the ECU storage section 320.

On the other hand, when it is determined that the current time falls within the use time indicated by the reservation information 2123 stored in the ECU storage section 320 (step SC5: YES), even when a generation trigger occurs, the authentication information generation section 313 does not newly generate start authorization authentication information 3202 (step SC6), but returns the process to step SC1.

Next, operation of the aforementioned authentication information generation section 313 will be described with specific examples.

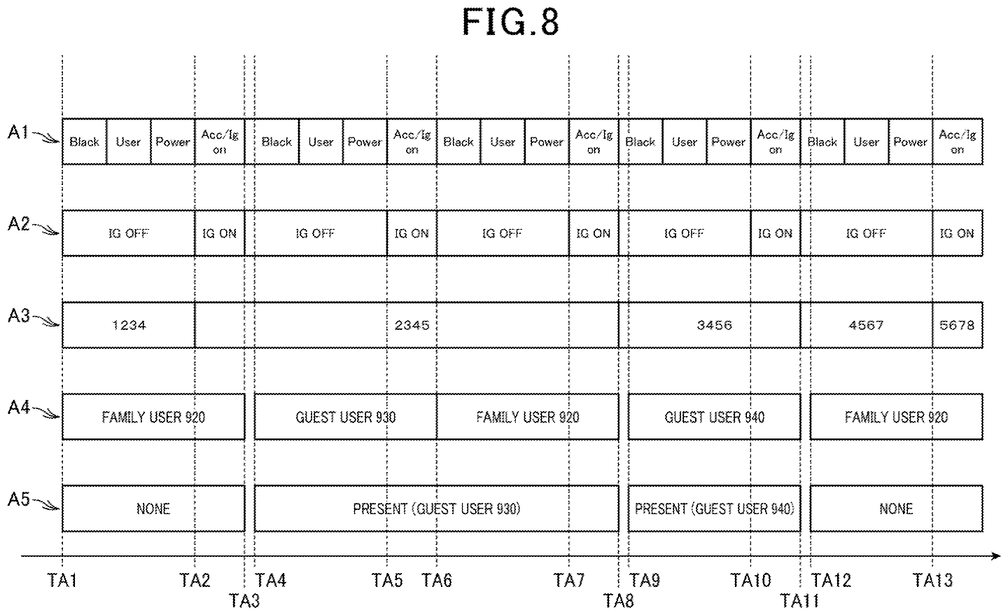

FIG. 8 is a time chart illustrating an example of a use situation of the vehicle 1 by a plurality of user 900.

In FIG. 8, a chart A1 shows a state of the display screen of the display unit 500A. In the chart A1, the state of the display screen with a character “Black” indicates a state in which information is not displayed. A state of the display screen with a character “User” in the chart A1 indicates a state in which the start authorization authentication information 3202 is displayed. A state of the display screen with a character “Power” in the chart A1 indicates guidance information for starting the vehicle 1. A state of the display screen with a character “Acc/Ig on” in the chart A1 indicates a state when ignition and accessory power supply are on. In the present embodiment, the display screen of the display unit 500A is switched in order of states shown by characters “Black,” “User,” “Power” and “Acc/Ig on” if each authentication is performed appropriately and the vehicle 1 is started. When the ignition and accessory power are turned off, the display screen is switched to the state indicated by the character “Black.”

In FIG. 8, a chart A2 shows a state of the vehicle 1. The state of the vehicle 1 with a character “IG OFF” in the chart A2 shows a state in which the ignition is off, that is, a state in which power to the drive motor or the like of the vehicle 1 is stopped. A state of the vehicle 1 with a character “IG ON” in the chart A2 shows a state in which the ignition is on and power is supplied to the drive motor or the like of the vehicle 1.

Furthermore, in FIG. 8, a chart A3 shows a state of the start authorization authentication information 3202. A sequence in the chart A3 is a specific example of the start authorization authentication information 3202. A chart A4 in FIG. 8 shows the user 900 who uses the vehicle 1. A chart A5 in FIG. 8 shows a situation of a use reservation of the vehicle 1.

At timing TA1, the family user 920 starts to use the vehicle 1. As shown in chart TAS, the family user 920 does not make a reservation to use the vehicle 1. When authentication is performed appropriately and the family user 920 turns on the vehicle start switch 401 at timing TA2, ignition is turned on as shown in the chart A2 and the vehicle 1 is enabled to start. In this case, the authentication information generation section 313 assumes that the generation trigger 1 has occurred and executes processes in steps SC1: YES, SC2: NO, SC5: NO, SC3 and SC4 in that order in FIG. 7. Therefore, the authentication information generation section 313 generates new start authorization authentication information 3202 of “2345” at timing TA2 as shown in the chart A3. While the family user 920 is using the vehicle 1, new start authorization authentication information 3202 of “2345” is stored in the ECU storage section 320. When timing TA3 is reached, the family user 920 turns off the vehicle start switch 401 and ends the use of the vehicle 1.

At timing TA4, it is assumed that the guest user 930 starts to use the vehicle 1 after the family user 920. The guest user 930 has made a reservation to use the vehicle 1. When the guest user 930 uses the vehicle 1, the authentication information notification section 314 notifies within the vehicle 1 the start authorization authentication information 3202 of “2345” generated when the family user 920 used the vehicle 1.

Thus, since the start authorization authentication information 3202 is generated before the family user 920 who is the previous user 900 turns off power of the vehicle 1, the authentication information generation section 313 need not generate new start authorization authentication information 3202 when the guest user 930 who is the user 900 this time starts to use the vehicle 1. Therefore, the authentication information notification section 314 can speedily notify the new start authorization authentication information 3202 and the guest user 930 can speedily start the vehicle 1. Therefore, the use control ECU 300 can make the vehicle 1 easy to use for the user 900.

When authentication is performed appropriately and when the guest user 930 turns on the vehicle start switch 401 at timing TA5, the vehicle 1 is enabled to start as shown in the chart A2. In this case, the authentication information generation section 313 assumes that the generation trigger 1 has occurred, and executes processes in steps SC1: YES, SC2: NO, SC5: YES, and SC6 in that order in FIG. 7. Therefore, the authentication information generation section 313 does not generate new start authorization authentication information 3202. Thus while the guest user 930 is using the vehicle 1, the start authorization authentication information 3202 of “2345” is continuously stored in the ECU storage section 320.

It is assumed that within the use time reserved by the guest user 930, the use of the vehicle 1 by the guest user 930 ends at timing TA6 and the family user 920 starts to use the vehicle 1. When the family user 920 uses the vehicle 1 within the use time reserved by the guest user 930, the authentication information notification section 314 notifies within the vehicle 1 the start authorization authentication information 3202 of “2345” notified within the vehicle 1 when the guest user 930 used the vehicle 1. When authentication is performed appropriately and the family user 920 turns on the vehicle start switch 401 at timing TA7, power is turned on as shown in the chart A2 and the vehicle 1 is enabled to start. In this case, the authentication information generation section 313 assumes that the generation trigger 1 has occurred, and executes processes in steps SC1: YES, SC2: NO, SC5: YES, and SC6 in that order in FIG. 7. Therefore, the authentication information generation section 313 does not generate new start authorization authentication information 3202. Thus, the start authorization authentication information 3202 of “2345” is stored continuously in the ECU storage section 320 even while the family user 920 is using the vehicle 1 within the use time of the guest user 930.

Thus, during the use time reserved by the guest user 930, even when a specific user such as the family user 920 uses the vehicle 1, the authentication information generation section 313 does not generate new start authorization authentication information 3202. FIG. 8 illustrates a case where the guest user 930 uses the vehicle 1 only once during the use time, but the power of the vehicle 1 can be turned on/off a plurality of times within the use time depending on the mode of use. In this case, if the guest user 930 is notified of start authorization authentication information 3202 which differs every time, the guest user 930 has to input start authorization authentication information 3202 which differs every time to the portable terminal 3C, which reduces ease of use of the vehicle 1. Therefore, the authentication information generation section 313 does not generate new start authorization authentication information 3202 during the use time reserved by the guest user 930. Thus, during the use time indicated by the use reservation, when the vehicle 1 is started, the user 900 is prevented from inputting start authorization authentication information 3202 which differs every time to the portable terminal 3. Thus, the use control ECU 300 can make the vehicle 1 one easy to use for the user 900.

It is assumed that at timing TA8, the guest user 930 turns off the vehicle start switch 401, ends the use of the vehicle 1 and the use management server 2 transmits a use end notification to the vehicle 1. In this case, the authentication information generation section 313 assumes that the generation trigger 4 has occurred and executes processes in step SC1: YES, step SC2: YES, steps SC3 and SC4 in that order in FIG. 7. Therefore, the authentication information generation section 313 generates new start authorization authentication information 3202 of “3456.” At timing TA8, new start authorization authentication information 3202 of “3456” is stored in the ECU storage section 320.

At timing TA9, the guest user 940 starts to use the vehicle 1 after the family user 920. The guest user 940 makes a reservation to use the vehicle 1 after the guest user 930. When the guest user 940 uses the vehicle 1, the authentication information notification section 314 notifies within the vehicle 1 the new start authorization authentication information 3202 of “3456” generated before the guest user 940 starts to use the vehicle 1.

Thus, the authentication information generation section 313 generates start authorization authentication information 3202 before starting the use of the vehicle 1 reserved by the guest user 940. Therefore, the authentication information generation section 313 need not generate new start authorization authentication information 3202 when the guest user 940 which is the user 900 this time starts to use the vehicle 1. Therefore, the authentication information notification section 314 can speedily notify new start authorization authentication information 3202 and the guest user 940 can speedily start the vehicle 1. The use control ECU 300 can thereby improve ease of use of the vehicle 1. Since the start authorization authentication information 3202 is generated before starting to use the vehicle 1 during the use time, only the guest user 940 is authorized to recognize the start authorization authentication information 3202 to start the vehicle 1 during the use time, and it is thereby possible to prevent unauthorized use of the vehicle 1. Therefore, the use control ECU 300 can improve security in using the vehicle 1.

When authentication is performed appropriately and the guest user 940 turns on the vehicle start switch 401 at timing TA10, the vehicle 1 can be started as shown in the chart A2. Since timing TA10 is within the use time of the guest user 940, the authentication information generation section 313 does not generate new start authorization authentication information 3202. Therefore, after timing TA10, the start authorization authentication information 3202 of “3456” is continuously stored in the ECU storage section 320.

At timing TA11, it is assumed that the guest user 940 turns off the vehicle start switch 401, ends the use of the vehicle 1 and the use management server 2 transmits a use end notification to the vehicle 1. In this case, since the authentication information generation section 313 executes the same process as the process at timing TA8, new start authorization authentication information 3202 of “4567” is generated. After timing TA11, new start authorization authentication information 3202 of “4567” is stored in the ECU storage section 320.

At timing TA12, it is assumed that the family user 920 has started to use the vehicle 1 after the guest user 940. The family user 920 has made no reservation to use the vehicle 1. When the family user 920 uses the vehicle 1, the authentication information notification section 314 notifies within the vehicle 1 the newly generated start authorization authentication information 3202 of “4567.” When authentication is performed appropriately and the family user 920 turns on the vehicle start switch 401 at timing TA13, the vehicle 1 is enabled to start as shown in the chart A2. Here, since the use control ECU 300 executes the same process as the process at timing TA2 in FIG. 7, the authentication information generation section 313 generates new start authorization authentication information 3202 of “5678.” After timing TA13, the start authorization authentication information 3202 of “5678” is stored in the ECU storage section 320.

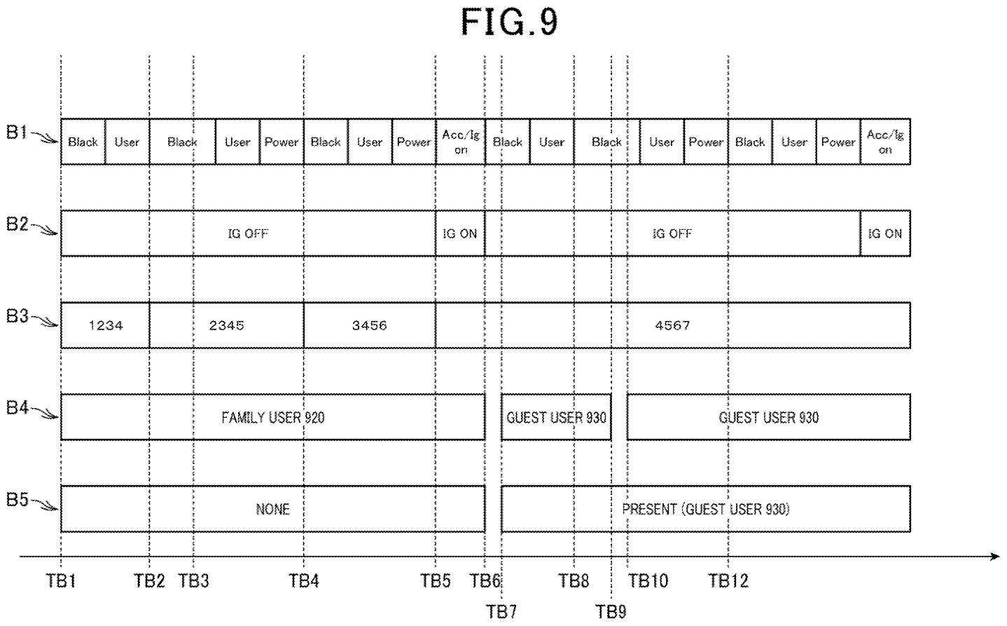

FIG. 9 is a time chart illustrating an example of a use situation of the vehicle 1 by a plurality of user 900.

In FIG. 9, a chart B1 shows a state of the display screen of the display unit 500A. In the chart B1, the state of the display screen indicated by each character is the same as that in FIG. 8. In FIG. 9, a chart B2 shows a state of the vehicle 1. In the chart B2, the states indicated by “IG OFF”, and “IG ON” are the same as those in FIG. 8. In FIG. 9, a chart B3 shows a state of the start authorization authentication information 3202. In the .chart B3, a sequence is a specific example of the start authorization authentication information 3202. In FIG. 9, a chart B4 shows the user 900 who uses the vehicle 1. In FIG. 9, a chart B5 shows a use reservation situation of the vehicle 1.

At timing TB1, the family user 920 starts to use the vehicle 1. The family user 920 has made no reservation to use the vehicle 1. It is assumed that for a predetermined reason, the family user 920 has made no request to start the vehicle 1 and at timing TB2, authentication times out based on the start authorization authentication information 3202. In this case, the authentication information generation section 313 assumes that the generation trigger 2 has occurred, and executes processes in steps SC1: YES, SC2: NO, SC4: YES, SC3 and SC4 in that order in FIG. 7. Therefore, the authentication information generation section 313 generates new start authorization authentication information 3202 of “2345.” New start authorization authentication information 3202 of “2345” generated by the authentication information generation section 313 is stored in the ECU storage section 320.

Thus, when authentication based on the start authorization authentication information 3202 times out, the authentication information generation section 313 generates new start authorization authentication information 3202. In this way, after a notification of the start authorization authentication information 3202 stops due to the timeout, when the start authorization authentication information 3202 is notified again, the authentication information notification section 314 never notifies the same start authorization authentication information 3202 as the previously notified start authorization authentication information 3202. It is thereby possible to prevent the vehicle 1 from being enabled to start with the start authorization authentication information 3202 notified until the timeout and thereby improve security in using the vehicle 1.

It is assumed that after timing TB2, the family user 920 does not use the vehicle 1 for a predetermined reason and the family user 920 starts to use the vehicle 1 again at timing TB3. This family user 920 has made no reservation to use the vehicle 1. Authentication is performed appropriately but the family user 920 does not turn on the vehicle start switch 401 for a predetermined reason and the start of the vehicle 1 has timed out at timing TB4. In this case, as shown in FIG. 6, the use control ECU 300 receives non-execution notification from the BCM 400. Therefore, the authentication information generation section 313 assumes that the generation trigger 3 has occurred and executes processes in steps SC1: YES, SC2: NO, SC5: NO, SC3 and SC4 in that order in FIG. 7. Therefore, the authentication information generation section 313 generates new start authorization authentication information 3202 of “3456.” New start authorization authentication information 3202 of “3456” generated by the authentication information generation section 313 is stored in the ECU storage section 320.

After timing TB4, it is assumed that authentication has been performed appropriately and the family user 920 turns on the vehicle start switch 401 at timing TB5. Then, the authentication information generation section 313 generates new start authorization authentication information 3202 of “4567.” New start authorization authentication information 3202 of “4567” generated by the authentication information generation section 313 is stored in the ECU storage section 320.

At timing TB6, the use of the vehicle 1 by the family user 920 is ended and at timing TB7, the guest user 930 starts to use the vehicle 1 after the family user 920. The guest user 930 has made a reservation to use the vehicle 1. It is assumed that for a predetermined reason, the guest user 930 has made no request to start the vehicle 1 and authentication based on the start authorization authentication information 3202 has timed out at timing TB8. In this case, the authentication information generation section 313 assumes that the generation trigger 2 has occurred and executes processes in steps SC1: YES, SC2: NO, SC5: YES and SC6 in that order in FIG. 7. Therefore, the authentication information generation section 313 does not generate new start authorization authentication information 3202. After transition to timing TB8, the start authorization authentication information 3202 of “4567” is continuously stored in the ECU storage section 320.

It is assumed that at timing TB9, the guest user 930 temporarily ends the use of the vehicle 1 for a predetermined reason and the guest user 930 starts to use the vehicle 1 again at timing TB10. The guest user 930 has made a reservation to use the vehicle 1. It is assumed that although authentication has been performed appropriately, the guest user 930 does not turn on the vehicle start switch 401 for a predetermined reason and the start of the vehicle 1 has timed out at timing TB11. In this case, as shown in FIG. 6, the use control ECU 300 receives non-execution notification from the BCM 400. Therefore, the authentication information generation section 313 assumes that the generation trigger 3 has occurred and executes processes in steps SC1: YES, SC2: NO, SC5: YES, and SC6 in FIG. 7. Therefore, the authentication information generation section 313 does not generate new start authorization authentication information 3202. After timing TB11, start authorization authentication information 3202 of “4567” is continuously stored in the ECU storage section 320.

In this way, during the use time indicated by the use reservation made by the guest user 930, even when a timeout of authentication and a timeout of start of the vehicle 1 occur, the authentication information generation section 313 does not generate new start authorization authentication information 3202. In this way, after the notification of the start authorization authentication information 3202 is stopped, when the start authorization authentication information 3202 is notified again, the authentication information notification section 314 can notify the same start authorization authentication information 3202 as the previously notified start authorization authentication information 3202. Depending on the mode of use of the guest user 930, a case may occur a plurality of times where although the user may get on the vehicle 1, the user may not immediately start the vehicle 1 within the use time. In this case, if the start authorization authentication information 3202 which differs every time is notified, the start authorization authentication information 3202 which differs every time is inputted to the portable terminal 3C, which reduces the ease of use of the vehicle 1. Therefore, within the use time, the authentication information generation section 313 does not generate new start authorization authentication information 3202 even when a notification of the start authorization authentication information 3202 is stopped due to a timeout. For this reason, within the use time, when starting the vehicle 1, it is possible to prevent input of start authorization authentication information 3202 which differs every time to the portable terminal 3 and the use control ECU 300 can make the vehicle 1 easy to use for the user 900.

### [6. Conclusions]

As described so far, the use control ECU 300 is provided with the ECU storage section 320 that stores wireless communication terminal information 3203 of the portable terminal 3, the ECU wireless communication section 330 that communicates with the portable terminal 3 based on the wireless communication terminal information 3203 stored in the ECU storage section 320, the authentication information generation section 313 that generates the start authorization authentication information 3202, the authentication information notification section 314 that notifies within the vehicle 1 the start authorization authentication information 3202, the vehicle start authentication section 316 that performs, when the ECU wireless communication section 330 receives the start authorization authentication information 3202 notified from the authentication information notification section 314 from the portable terminal 3, authentication related to starting the vehicle 1 based on the received start authorization authentication information 3202, and the vehicle start authorization section 317 that authorizes the start of the vehicle 1 based on the authentication result of the vehicle start authentication section 316.

Accordingly, the user 900 needs to recognize the start authorization authentication information 3202 notified within the vehicle 1 to cause the portable terminal 3 to start the vehicle 1. Therefore, the user 900 needs to get on the vehicle 1 so as to cause the portable terminal 3 to start the vehicle 1. Therefore, even with the configuration of automatically communicating and getting connected with the portable terminal 3, the use control ECU 300 can prevent the vehicle 1 from being enabled to start at a position apart from the user 900 due to misoperation of the user 900 or the like. For this reason, the use control ECU 300 can prevent unauthorized use of the vehicle 1 that can be started from the portable terminal 3.

Furthermore, the use control ECU 300 is provided with the elapsed time measurement section 315 that measures an elapsed time after the authentication information notification section 314 notifies the start authorization authentication information 3202. When the elapsed time measured by the elapsed time measurement section 315 reaches a predetermined time, the authentication information notification section 314 stops the notification of the start authorization authentication information 3202 within the vehicle 1.

It is thereby possible to prevent the start authorization authentication information 3202 from being notified unnecessarily for a long period of time without any request to start the vehicle 1 from the portable terminal 3 and prevent power consumption from increasing due to the notification of the start authorization authentication information 3202.

After causing the authentication information notification section 314 to stop the notification within the vehicle 1, the authentication information generation section 313 generates the start authorization authentication information 3202.

Thus, when notifying the start authorization authentication information 3202 again after stopping the notification of the start authorization authentication information 3202, the authentication information notification section 314 never notifies the same start authorization authentication information 3202 as the previously notified start authorization authentication information 3202. Therefore, it is possible to prevent the vehicle 1 from being enabled to start with the start authorization authentication information 3202 notified until a predetermined time is reached and thereby improve security in using the vehicle 1.

The authentication information generation section 313 generates the start authorization authentication information 3202 related to the next start of the vehicle 1 before power of the vehicle 1 is turned off.

This eliminates the necessity for the authentication information generation section 313 to generate new start authorization authentication information 3202 when the user 900 starts to use the vehicle 1. Therefore, the authentication information notification section 314 can speedily notify the new start authorization authentication information 3202 and the user 900 can cause the vehicle 1 to start speedily.

The use control ECU 300 is provided with the information collection section 311 that acquires a reservation to use the vehicle 1 including the use time of the vehicle 1. The authentication information generation section 313 does not newly generate start authorization authentication information during the use time of the vehicle 1 included in the use reservation acquired by the information collection section 311.

According to this configuration, when starting the vehicle 1 within the use time, the user 900 need not input a different piece of start authorization authentication information 3202 which differs every time to the portable terminal 3 but just input the same start authorization authentication information 3202. It is therefore possible to prevent operation of the user 900 performed when using the vehicle 1 from becoming complicated, and the use control ECU 300 can make the vehicle 1 easy to use for the user 900.

The authentication information generation section 313 generates start authorization authentication information 3202 before starting to use the vehicle 1 during the use time of the vehicle 1.

This eliminates the necessity for the authentication information generation section 313 to generate the new start authorization authentication information 3202 when starting to use the vehicle 1 with a use reservation. Therefore, the authentication information notification section 314 can speedily notify the new start authorization authentication information 3202 and can speedily start the vehicle 1 when using the vehicle 1 with the use reservation. Therefore, the use control ECU 300 can improve ease of use of the vehicle 1. Furthermore, since the start authorization authentication information 3202 is generated before starting to use the vehicle 1 during the use time, only the user 900 who has made a use reservation can recognize the start authorization authentication information 3202 to start the vehicle 1 during the use time. It is thereby possible to prevent unauthorized use of the vehicle 1 and improve security in using the vehicle 1.

### [7. Other Embodiments]

Note that the present invention is not limited to the configurations of the above embodiments, but can be implemented in various modes without departing from the spirit and scope the invention.

For example, when issuing a valid electronic key 800 in a reserved use time zone, the use management server 2 in the present embodiment includes the use time information 2122 in the electronic key 800, but the present invention is not limited to this. The use management server 2 may be configured to generate the electronic key 800 having only the electronic key basic information 2112. In this case, for example, the information collection section 311 of the vehicle-mounted system 100 inquires of the use management server 2 about the reservation ID 2121 and the use time information 2122 set for the electronic key 800 used for the vehicle 1 and acquires the reservation ID 2121 and the use time information 2122.

Furthermore, for example, the vehicle 1 may be a vehicle that can be manually operated to travel by the driver performing drive-related operation or a vehicle that can be automatically operated to automatically travel without the driver performing drive-related operation. Furthermore, the vehicle 1 is a vehicle such as an engine-driven four-wheel vehicle, a motor-driven electric vehicle, a hybrid vehicle mounted with a motor and an engine. Note that the vehicle 1 may be a vehicle other than a four-wheel vehicle.

For example, in the above-described embodiments, the blocks shown in FIG. 5 are schematic diagrams illustrating components classified according to main processing contents to facilitate an understanding of the present invention and the blocks can also be classified into still more components according to the processing contents. Furthermore, one component can be classified so as to execute still more processes.

For example, step units of operation shown in FIG. 6 and FIG. 7 are classified according to main processing contents to facilitate an understanding of operation of the vehicle-mounted system 100 and the use control ECU 300, and the present invention is never limited by the way how to divide the processing units or the names. The step units of operation may be divided into still more step units according to the processing contents. The step units of operation may also be divided such that one step unit includes still more processes. The order of steps may be switched round as appropriate without departing from the spirit and scope of the present invention.

### [Description of the Numerals]

1 . . . vehicle, 3, 3B, 3C, 3D . . . portable terminal, 100 . . . vehicle-mounted system, 300 . . . use control ECU (vehicle control unit), 310 . . . ECU processing section, 311 . . . information collection section (use reservation acquisition section), 312 . . . door lock authentication section, 313 . . . authentication information generation section, 314 . . . authentication information notification section, 315 . . . elapsed time measurement section, 316 . . . vehicle start authentication section, 317 . . . vehicle start authorization section, 320 . . . ECU storage section (storage section), 330 . . . ECU wireless communication section (communication section), 340 . . . ECU bus communication section, 400 . . . BCM , 401 . . . vehicle start switch, 402 . . . power supply system, 403 . . . door lock mechanism, 410 . . . BCM processing section, 411 . . . start operation detection section, 412 . . . FOB communication section, 413 . . . power control section, 414 . . . door control section, 420 . . . BCM storage section, 430 . . . BCM wireless communication section, 440 . . . BCM bus communication section, 500 . . . application execution unit, 600 . . . TCU, 700 . . . vehicle-mounted network bus, 2123 . . . reservation information, 3201 . . . vehicle-side user DB, 3202 . . . start authorization authentication information (authentication information), 3203 . . . wireless communication terminal information (terminal information).

What is claimed is:

1. A vehicle control apparatus comprising:
a storage section that stores terminal information on a portable terminal;
a communication section that communicates with the portable terminal based on the terminal information stored in the storage section;
an authentication information generation section that generates authentication information to authorize the vehicle to start;
an authentication information notification section that notifies within the vehicle the authentication information generated by the authentication information generation section;
a vehicle start authentication section that performs, when the authentication information notified from the authentication information notification section is received by the communication section from the portable terminal, authentication related to starting the vehicle based on the received authentication information; and
a vehicle start authorization section that authorizes the vehicle to start based on an authentication result of the vehicle start authentication section.

2. The vehicle control apparatus according to claim 1, further comprising an elapsed time measurement section that measures an elapsed time after the authentication information is notified from the authentication information notification section, wherein when the elapsed time measured by the elapsed time measurement section reaches a predetermined time, the authentication information notification section stops notification of the authentication information within the vehicle.

3. The vehicle control apparatus according to claim 2, wherein the authentication information generation section generates the authentication information after the authentication information notification section stops notification within the vehicle.

4. The vehicle control apparatus according to claim 1, wherein the authentication information generation section generates the authentication information relating to the next start of the vehicle before power of the vehicle is turned off.

5. The vehicle control apparatus according to claim 1, further comprising a use reservation acquisition section that acquires a reservation to use the vehicle including a use time of the vehicle, wherein the authentication information generation section does not newly generate the authentication information during the use time included in the use reservation acquired by the use reservation acquisition section.

6. The vehicle control apparatus according to claim 5, wherein the authentication information generation section generates the authentication information before starting to use the vehicle during the use time.
